(19) United States
(12) Patent Application Publication
(10) Pub. No.: US 2024/0256340 A1
(43) Pub. Date: Aug. 1, 2024

(54) METHOD AND SYSTEM FOR FACILITATING AUTOMATED POOL MANAGEMENT

(71) Applicant: JPMorgan Chase Bank, N.A., New York, NY (US)

(72) Inventors: Varun MONGA, Newark, DE (US); Somnath CHOUDHURI, Newark, DE (US); Dan BODALSKI, Swedesboro, NJ (US); Nada ZIAB, Wilmington, DE (US)

(73) Assignee: JPMorgan Chase Bank, N.A., New York, NY (US)

(21) Appl. No.: 18/104,614

(22) Filed: Feb. 1, 2023

(51) Int. Cl. G06F 9/50

(52) U.S. Cl. CPC G06F 9/5027

(57) ABSTRACT

A method for providing end-to-end monitoring to facilitate automated resource pool management in a cloud computing environment is disclosed. The method includes aggregating, in real-time from an application programming interface gateway, operating metrics for resource pools; parsing the aggregated operating metrics to discover latency metrics for each of the resource pools; identifying a threshold for each of the resource pools, the threshold corresponding to the latency metrics; comparing the latency metrics for each of the resource pools with the corresponding threshold; automatically determining a remediation action based on a result of the comparing; and automatically initiating, in real-time, the remediation action.

### BACKGROUND

### 1. Field of the Disclosure

This technology generally relates to methods and systems for managing resource pools, and more particularly to methods and systems for providing end-to-end monitoring outside an application boundary to facilitate automated resource pool management in a cloud computing environment.

### 2. Background Information

Many business entities implement high-volume application programming interfaces (APIs) to serve numerous application flows and resource pools in a cloud computing environment. Often, the high-volume APIs support critical systems which require a highly resilient operating environment. Historically, implementations of conventional resiliency and monitoring techniques have resulted in varying degrees of success with respect to coverage for entire API call and response paths across full sets of computing components, services, and infrastructures.

One drawback of using the conventional resiliency and monitoring techniques is that in many instances, existing tools focus primarily on performance of the applications themselves. As a result, gaps in resiliency and monitoring remain as there are no end-to-end monitoring at a layer outside the application boundary. More specifically, the gaps may result because existing tools do not address and/or provide health checks for service latency detection within, or outside of, the application instance; health checks for non-binary conditions; notification mechanisms such as, for example, an email alert or an ability to call to a service end-point to enable further automation within the health check framework; and ability to ensure sufficient resource pools to maintain minimum service level agreements (SLAs) with consumers.

Therefore, there is a need to provide end-to-end monitoring of operating metrics such as, for example, latency metrics outside an application boundary to facilitate automated resource pool management and remediation in a cloud computing environment.

### SUMMARY

The present disclosure, through one or more of its various aspects, embodiments, and/or specific features or sub-components, provides, inter alia, various systems, servers, devices, methods, media, programs, and platforms for providing end-to-end monitoring outside an application boundary to facilitate automated resource pool management in a cloud computing environment.

According to an aspect of the present disclosure, a method for providing end-to-end monitoring to facilitate automated resource pool management in a cloud computing environment is disclosed. The method is implemented by at least one processor. The method may include aggregating, in real-time from an application programming interface gateway, a plurality of operating metrics for at least one resource pool; parsing the aggregated plurality of operating metrics to discover at least one latency metric for each of the at least one resource pool; identifying at least one threshold for each of the at least one resource pool, the at least one threshold may correspond to the at least one latency metric; comparing the at least one latency metric for each of the at least one resource pool with the corresponding at least one threshold; automatically determining at least one remediation action based on a result of the comparing; and automatically initiating, in real-time, the at least one remediation action.

In accordance with an exemplary embodiment, the method may further include generating at least one email alert, the at least one email alert may include information that relates to the at least one latency metric, the at least one threshold, the at least one resource pool, and the at least one remediation action; identifying at least one responsible user based on the at least one resource pool; and transmitting the at least one email alert to the at least one responsible user.

In accordance with an exemplary embodiment, the at least one latency metric may correspond to a communication time delay in a network flow of the at least one resource pool, the at least one resource pool may relate to an application instance in the cloud computing environment.

In accordance with an exemplary embodiment, to identify the at least one threshold for each of the at least one resource pool, the method may further include aggregating historical data for each of the at least one resource pool, the historical data may include persisted information that relates to the plurality of operating metrics; identifying, by using at least one model, at least one failure pattern based on the aggregated historical data; determining the at least one threshold based on the at least one failure pattern; and associating the determined at least one threshold with the corresponding at least one resource pool, wherein the at least one model may include at least one from among a machine learning model, a mathematical model, a process model, and a data model.

In accordance with an exemplary embodiment, to compare the at least one latency metric with the corresponding at least one threshold, the method may further include determining, for each of the at least one resource pool, a failure condition based on the at least one latency metric and the corresponding at least one threshold; and determining a failure level for the failure condition, the failure level may correspond to a criticality of the failure condition according to a predetermined guideline.

In accordance with an exemplary embodiment, to automatically determine the at least one remediation action, the method may further include determining, by using at least one model, the at least one remediation action based on the failure condition and the corresponding failure level, the at least one remediation action may include at least one from among an alerting action and a corrective action; identifying, by using the plurality of operating metrics, an amount of the at least one resource pool that satisfies a predetermined operating requirement, the predetermined operating requirement may relate to a minimum operating capacity of the cloud computing environment; and validating the at least one remediation action based on the identified amount, wherein the alerting action may correspond to an automated notification of a potential failure as determined by the at least one model; and wherein the corrective action may correspond to an automated disabling of network traffic to the at least one resource pool.

In accordance with an exemplary embodiment, to automatically initiate the at least one remediation action, the method may further include generating at least one request with instructions that correspond to the at least one remediation action; transmitting the at least one request to a network application programming interface that manages data flow for the at least one resource pool; and confirming that the at least one remediation action is completed based on a response from the network application programming interface.

In accordance with an exemplary embodiment, the method may further include monitoring the at least one resource pool by using the plurality of operating metrics; determining that at least one disabled resource pool is operational according to predetermined criteria; and reintegrating the at least one disabled resource pool back into the cloud computing environment.

In accordance with an exemplary embodiment, the method may further include aggregating information that corresponds to at least one from among the at least one resource pool, the plurality of operating metrics, the at least one latency metric, the at least one threshold, and the at least one remediation action; generating at least one graphical representation of the aggregated information, the at least one graphical representation may correspond to a dashboard that includes the aggregated information; and displaying, via a graphical user interface, the at least one graphical representation.

According to an aspect of the present disclosure, a computing device configured to implement an execution of a method for providing end-to-end monitoring to facilitate automated resource pool management in a cloud computing environment is disclosed. The computing device including a processor; a memory; and a communication interface coupled to each of the processor and the memory, wherein the processor may be configured to aggregate, in real-time from an application programming interface gateway, a plurality of operating metrics for at least one resource pool; parse the aggregated plurality of operating metrics to discover at least one latency metric for each of the at least one resource pool; identify at least one threshold for each of the at least one resource pool, the at least one threshold may correspond to the at least one latency metric; compare the at least one latency metric for each of the at least one resource pool with the corresponding at least one threshold; automatically determine at least one remediation action based on a result of the comparing; and automatically initiate, in real-time, the at least one remediation action.

In accordance with an exemplary embodiment, the processor may be further configured to generate at least one email alert, the at least one email alert may include information that relates to the at least one latency metric, the at least one threshold, the at least one resource pool, and the at least one remediation action; identify at least one responsible user based on the at least one resource pool; and transmit the at least one email alert to the at least one responsible user.

In accordance with an exemplary embodiment, the at least one latency metric may correspond to a communication time delay in a network flow of the at least one resource pool, the at least one resource pool may relate to an application instance in the cloud computing environment.

In accordance with an exemplary embodiment, to identify the at least one threshold for each of the at least one resource pool, the processor may be further configured to aggregate historical data for each of the at least one resource pool, the historical data may include persisted information that relates to the plurality of operating metrics; identify, by using at least one model, at least one failure pattern based on the aggregated historical data; determine the at least one threshold based on the at least one failure pattern; and associate the determined at least one threshold with the corresponding at least one resource pool, wherein the at least one model may include at least one from among a machine learning model, a mathematical model, a process model, and a data model.

In accordance with an exemplary embodiment, to compare the at least one latency metric with the corresponding at least one threshold, the processor may be further configured to determine, for each of the at least one resource pool, a failure condition based on the at least one latency metric and the corresponding at least one threshold; and determine a failure level for the failure condition, the failure level may correspond to a criticality of the failure condition according to a predetermined guideline.

In accordance with an exemplary embodiment, to automatically determine the at least one remediation action, the processor may be further configured to determine, by using at least one model, the at least one remediation action based on the failure condition and the corresponding failure level, the at least one remediation action may include at least one from among an alerting action and a corrective action; identify, by using the plurality of operating metrics, an amount of the at least one resource pool that satisfies a predetermined operating requirement, the predetermined operating requirement may relate to a minimum operating capacity of the cloud computing environment; and validate the at least one remediation action based on the identified amount, wherein the alerting action may correspond to an automated notification of a potential failure as determined by the at least one model; and wherein the corrective action may correspond to an automated disabling of network traffic to the at least one resource pool.

In accordance with an exemplary embodiment, to automatically initiate the at least one remediation action, the processor may be further configured to generate at least one request with instructions that correspond to the at least one remediation action; transmit the at least one request to a network application programming interface that manages data flow for the at least one resource pool; and confirm that the at least one remediation action is completed based on a response from the network application programming interface.

In accordance with an exemplary embodiment, the processor may be further configured to monitor the at least one resource pool by using the plurality of operating metrics; determine that at least one disabled resource pool is operational according to predetermined criteria; and reintegrate the at least one disabled resource pool back into the cloud computing environment.

In accordance with an exemplary embodiment, the processor may be further configured to aggregate information that corresponds to at least one from among the at least one resource pool, the plurality of operating metrics, the at least one latency metric, the at least one threshold, and the at least one remediation action; generate at least one graphical representation of the aggregated information, the at least one graphical representation may correspond to a dashboard that includes the aggregated information; and display, via a graphical user interface, the at least one graphical representation.

According to an aspect of the present disclosure, a non-transitory computer readable storage medium storing instructions for providing end-to-end monitoring to facilitate automated resource pool management in a cloud computing environment is disclosed. The storage medium including executable code which, when executed by a processor, may cause the processor to aggregate, in real-time from an application programming interface gateway, a plurality of operating metrics for at least one resource pool; parse the aggregated plurality of operating metrics to discover at least one latency metric for each of the at least one resource pool; identify at least one threshold for each of the at least one resource pool, the at least one threshold may correspond to the at least one latency metric; compare the at least one latency metric for each of the at least one resource pool with the corresponding at least one threshold; automatically determine at least one remediation action based on a result of the comparing; and automatically initiate, in real-time, the at least one remediation action.

In accordance with an exemplary embodiment, the at least one latency metric may correspond to a communication time delay in a network flow of the at least one resource pool, the at least one resource pool may relate to an application instance in the cloud computing environment.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing end-to-end monitoring outside an application boundary to facilitate automated resource pool management in a cloud computing environment.

FIG. 4 is a flowchart of an exemplary process for implementing a method for providing end-to-end monitoring outside an application boundary to facilitate automated resource pool management in a cloud computing environment.

FIG. 5 is an architecture diagram of an exemplary process for implementing a method for providing end-to-end monitoring outside an application boundary to facilitate automated resource pool management in a cloud computing environment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

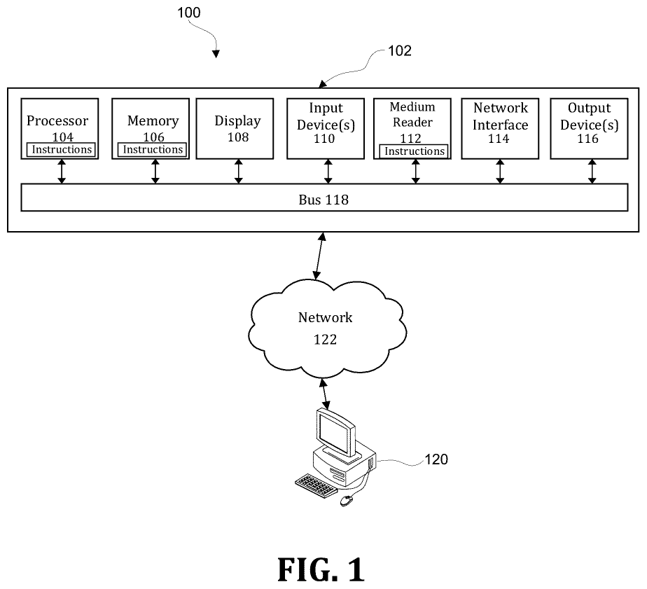

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing end-to-end monitoring outside an application boundary to facilitate automated resource pool management in a cloud computing environment.

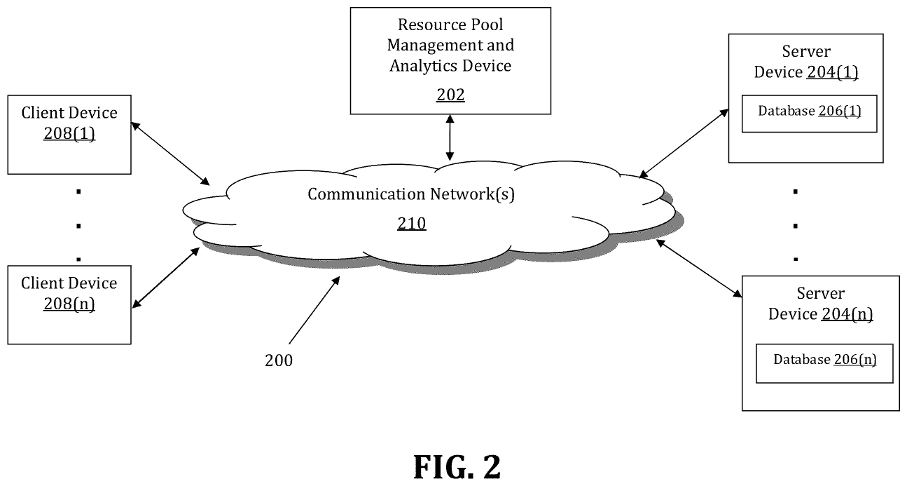

Referring to FIG. 2, a schematic of an exemplary network environment 200 for implementing a method for providing end-to-end monitoring outside an application boundary to facilitate automated resource pool management in a cloud computing environment is illustrated. In an exemplary embodiment, the method is executable on any networked computer platform, such as, for example, a personal computer (PC).

The method for providing end-to-end monitoring outside an application boundary to facilitate automated resource pool management in a cloud computing environment may be implemented by a Resource Pool Management and Analytics (RPMA) device 202. The RPMA device 202 may be the same or similar to the computer system 102 as described with respect to FIG. 1. The RPMA device 202 may store one or more applications that can include executable instructions that, when executed by the RPMA device 202, cause the RPMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RPMA device 202 itself, may be located in virtual server(s) running in a cloud-based computing environment rather than being tied to one or more specific physical network computing devices. Also, the application(s) may be running in one or more virtual machines (VMs) executing on the RPMA device 202. Additionally, in one or more embodiments of this technology, virtual machine(s) running on the RPMA device 202 may be managed or supervised by a hypervisor.

In the network environment 200 of FIG. 2, the RPMA device 202 is coupled to a plurality of server devices 204(1)-204(n) that hosts a plurality of databases 206(1)-206(n), and also to a plurality of client devices 208(1)-208(n) via communication network(s) 210. A communication interface of the RPMA device 202, such as the network interface 114 of the computer system 102 of FIG. 1, operatively couples and communicates between the RPMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RPMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RPMA devices that efficiently implement a method for providing end-to-end monitoring outside an application boundary to facilitate automated resource pool management in a cloud computing environment.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RPMA device 202 may be a standalone device or integrated with one or more other devices or apparatuses, such as one or more of the server devices 204(1)-204(n), for example. In one particular example, the RPMA device 202 may include or be hosted by one of the server devices 204(1)-204(n), and other arrangements are also possible. Moreover, one or more of the devices of the RPMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RPMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to operating metrics, resource pools, latency metrics, thresholds, remediation actions, historical data, failure patterns, and machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RPMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RPMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the RPMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RPMA device 202, the server devices 204(1)-204(n), or the client devices 208(1)-208(n), for example, may be configured to operate as virtual instances on the same physical machine. In other words, one or more of the RPMA device 202, the server devices 204(1)-204(n), or the client devices 208(1)-208(n) may operate on the same physical device rather than as separate devices communicating through communication network(s) 210. Additionally, there may be more or fewer RPMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

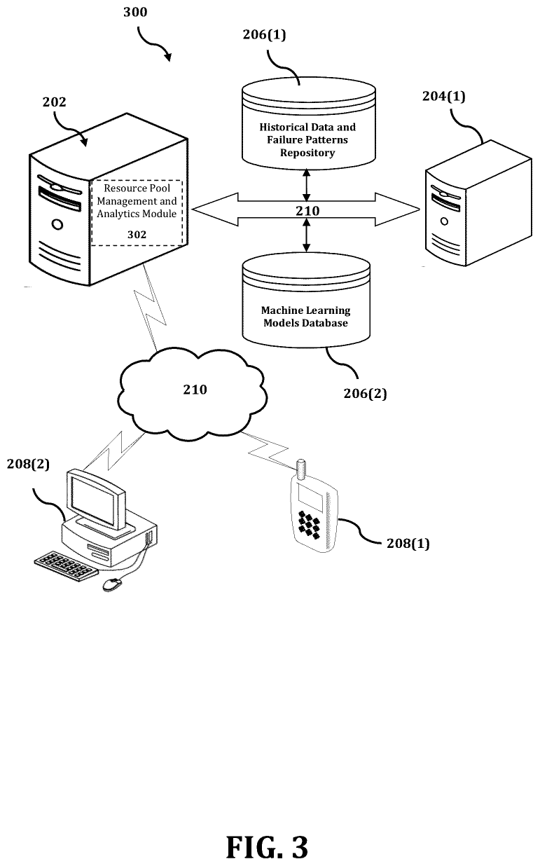

The RPMA device 202 is described and shown in FIG. 3 as including a resource pool management and analytics module 302, although it may include other rules, policies, modules, databases, or applications, for example. As will be described below, the resource pool management and analytics module 302 is configured to implement a method for providing end-to-end monitoring outside an application boundary to facilitate automated resource pool management in a cloud computing environment.

An exemplary process 300 for implementing a mechanism for providing end-to-end monitoring outside an application boundary to facilitate automated resource pool management in a cloud computing environment by utilizing the network environment of FIG. 2 is shown as being executed in FIG. 3. Specifically, a first client device 208(1) and a second client device 208(2) are illustrated as being in communication with RPMA device 202. In this regard, the first client device 208(1) and the second client device 208(2) may be “clients” of the RPMA device 202 and are described herein as such. Nevertheless, it is to be known and understood that the first client device 208(1) and/or the second client device 208(2) need not necessarily be “clients” of the RPMA device 202, or any entity described in association therewith herein. Any additional or alternative relationship may exist between either or both of the first client device 208(1) and the second client device 208(2) and the RPMA device 202, or no relationship may exist.

Further, RPMA device 202 is illustrated as being able to access a historical data and failure patterns repository 206(1) and a machine learning models database 206(2). The resource pool management and analytics module 302 may be configured to access these databases for implementing a method for providing end-to-end monitoring outside an application boundary to facilitate automated resource pool management in a cloud computing environment.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the RPMA device 202 via broadband or cellular communication. Of course, these embodiments are merely exemplary and are not limiting or exhaustive.

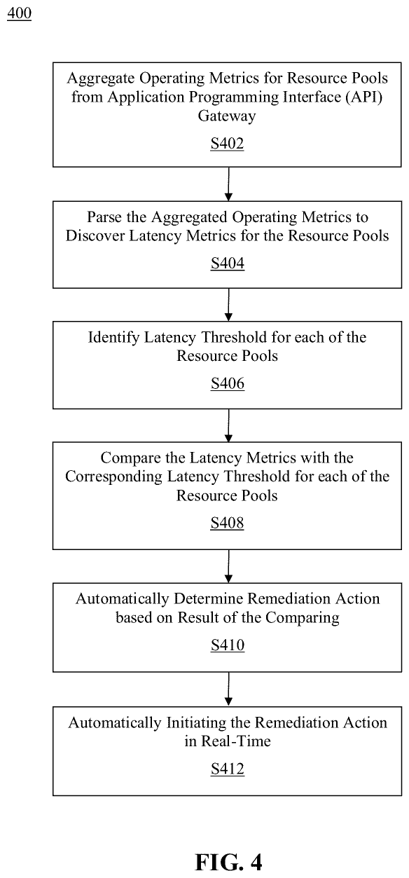

Upon being started, the resource pool management and analytics module 302 executes a process for providing end-to-end monitoring outside an application boundary to facilitate automated resource pool management in a cloud computing environment. An exemplary process for providing end-to-end monitoring outside an application boundary to facilitate automated resource pool management in a cloud computing environment is generally indicated at flowchart 400 in FIG. 4.

In the process 400 of FIG. 4, at step S402, operating metrics may be aggregated for resource pools. The operating metrics may be aggregated in real-time from an application programming interface (API) gateway. In an exemplary embodiment, the operating metrics may relate to measurements of parameters that correspond to the resource pools. Each of the resource pools may be monitored for performance, availability, reliability, as well as other operational attributes. For example, the operating metrics may include the amount of central processing units (CPUs) on a node as well as the amount of CPU usage on the node.

In another exemplary embodiment, the resource pools may correspond to a collection of computing resources in a cloud computing environment. The computing resources may be grouped into pools based on a shared commonality such as, for example, a particular application instance. In another exemplary embodiment, the resource pools in the cloud computing environment may operate in a separate computing layer from support interfaces such as, for example, application programming interfaces (APIs) and resource management applications such as, for example, enterprise observability platforms. The resource pools may communicate with other computing components in a networked environment via management tools such as, for example, an API gateway that sits between a client and the resource pools.

In another exemplary embodiment, the API gateway may serve as a reverse proxy to accept all API calls, aggregate the various services required to fulfill the API calls, and return the appropriate results in response to the API calls. The API gateway may manage common tasks that are used across a system of API services such as, for example, user authentication, rate limiting, and statistics. In another exemplary embodiment, the API gateway may facilitate aggregation of operating metrics in real-time. The API gateway, through its normal functionality, may aggregate statistics and operating metrics related to the network flows of the resource pools.

In another exemplary embodiment, aggregation of operating metrics at the API gateway enables coverage of entire API call and response paths across the full set of computing components, services, and infrastructures. Coverage of the entire API call and response paths may enable end-to-end monitoring of the resource pools. In another exemplary embodiment, aggregation of operating metrics at the API gateway may facilitate identification of platform issues with network appliances because the operating metrics provide insight at a layer outside the application boundary. For example, aggregation of operating metrics for an application at the API gateway may allow for the detection of latency of the application at a layer outside of the application boundary. As such, latency due to platform issues with network appliances associated with the application may be detected.

At step S404, the aggregated operating metrics may be parsed to discover latency metrics for each of the resource pools. In an exemplary embodiment, the latency metrics may correspond to a communication time delay in a network flow of the resource pools. The latency metrics may relate to measurements of the time delay between when a message such as, for example, a call was sent and when a response was received. Consistent with present disclosures, the latency may be measured for communications between the resource pools and a client such as, for example, a hypertext transfer protocol (HTTP) client.

In another exemplary embodiment, the operating metrics may be retrieved from resource management applications such as, for example, a SPLUNK application as data logs. The data logs may correspond to a record of events that occurred at the API gateway. The data logs may include information corresponding to the events such as, for example, error information and/or current operating statistics. In another exemplary embodiment, the aggregated operating metrics may be converted from one format to another to facilitate discovery of the latency metrics. For example, the operating metrics may be aggregated in an unstructured data format that must be structured prior to additional processing. Consistent with present disclosures, the latency metrics may be extracted from the operating metrics and mapped to each of the resource pools.

At step S406, thresholds may be identified for each of the resource pools. The thresholds may correspond to the latency metrics. In an exemplary embodiment, the threshold may relate to an amount, a level, and/or a limit on a predetermined scale. The threshold may be representative of a magnitude and/or an intensity that must be exceeded for a condition to occur or be manifested.

In another exemplary embodiment, identification of the thresholds for each of the resource pools may be accomplished manually by a user. The thresholds may be received from a user via an application programming interface and associated with the corresponding resource pools. In another exemplary embodiment, the threshold may be received as a batch input from the user. Consistent with present disclosures, the thresholds for each of the resource pools may be identified from the batch input and associated with the corresponding resource pools.

In another exemplary embodiment, identification of the thresholds for each of the resource pools may be accomplished automatically by using a model such as, for example, a machine learning model. To facilitate the automated identification, historical data for each of the resource pools may be aggregated. The historical data may be aggregated based on a predetermined time period and may include persisted information that relates to the plurality of operating metrics. For example, historical data for the past year may be aggregated for the resource pools to facilitate the automated identification.

Then, failure patterns may be identified by using the model. The failure patterns may be identified based on the aggregated historical data. The failure pattern may correspond to regularities in pool parameters from the aggregated historical data that have been recognized by the model as resulting in a failure. The thresholds may be determined for the resource pools based on the identified failure patterns. The thresholds may be determined for a grouping of the resource pools as well as for each of the resource pools. The thresholds may be determined based on the failure pattern to ensure that corrective actions may be taken prior to actual failure when potential failures are anticipated based on current pool parameters. For example, when the thresholds for a resource pool is exceeded, a potential failure of the resource pool may be anticipated. The determined thresholds may be associated with corresponding resource pools.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S408, the latency metrics for each of the resource pools may be compared with the corresponding thresholds. In an exemplary embodiment, the latency metrics and the corresponding thresholds may be evaluated based on relevant and comparable characteristics such as, for example, a latency value. The characteristics may be compared to determine similarities, differences, and to what degree.

In another exemplary embodiment, a failure condition may be determined for each of the resource pools. The failure condition may be determined based on the latency metrics and the corresponding thresholds. The failure conditions may correspond to production incidents that occur due to latency within or outside of an application instance such as, for example, a noisy neighbor incident, a repave activity incident, a router hung state incident, a network related incident, and general stability incident.

In the noisy neighbor incident, the application itself may be healthy, but other applications in the same pool are utilizing more resources, which causes latency to consumers of the application. In the repave activity incident, repave pool events may result in application latency. In the router hung state incident, a process on the routers in the cloud computing environment may become processor intensive resulting in a hung and/or slow responding router. In the network related incident, the application may be impacted by network issues which resulted in latency and timeouts for consumers of the application. In the general stability incident, general instability may result in manual routing of network traffic away from the impacted pools.

In another exemplary embodiment, a failure level may be determined for the failure condition. The failure level may correspond to a criticality of the failure condition according to a predetermined guideline. The failure level may include a plurality of intensities which ranges from partial failures to complete failure of the resource pool. The failure level may be assigned a value and/or a graphical element that represents the severity of the failure. For example, a less severe failure may be assigned a lower value and a more severe failure may be assigned a higher value. The failure level may be usable to determine whether an automated corrective action is required to immediately resolve the issue or merely an alert to a responsible user is required to provide notification of potential consumer impact. In another exemplary embodiment, the failure level may reflect the magnitude with which the threshold has been exceeded. For example, a severe failure may result when the threshold has been massively exceeded.

At step S410, remediation actions may be automatically determined based on a result of the comparing. In an exemplary embodiment, the remediation actions may be determined based on the failure condition and the corresponding failure level. The remediation actions may be determined by using the model and may include at least one from among an alerting action and a corrective action. The alerting action may correspond to an automated notification of a potential failure as determined by the model. The alerting action may be utilized when the failure level indicates that the failure condition is minor. Immediate action may not be required when the failure condition is minor. The corrective action may correspond to an automated disabling of network traffic to at least one of the resource pools. The corrective action may be utilized when the failure level indicated that the failure condition is severe. Immediate action may be required when the failure condition is severe.

Then, an amount of the resource pool that satisfies predetermined operating requirements may be identified by using the operating metrics. The predetermined operating requirements may relate to a minimum operating capacity of the cloud computing environment. For example, the predetermined operating requirements may indicate that at least four out of seven resource pools must be operating to ensure application functionality. The remediation action may be validated based on the identified amount to ensure that the minimum operating capacity is sufficiently met. For example, the remediation action may require the disabling of a few resource pools. Validating the remediation action would ensure that an adequate number of resource pools are still operational to make sure that the minimum operating capacity is met.

At step S412, the determined remediation actions may be automatically initiated in real-time. In an exemplary embodiment, to automatically initiate the remediation action, a request with instructions that correspond to the remediation action may be generated. The request may correspond to an API message such as, for example, a call that directs a computing component. The request may be transmitted to a network application programming interface such as, for example, a convenience API that manages data flow for the resource pools. Then, completion of the remediation action may be confirmed based on a response from the network application programming interface.

In another exemplary embodiment, the resource pools may be monitored by using the operating metrics. The resource pools may be continuously monitored to ascertain an operability condition. Then, a disabled resource pool may be determined to be operational according to predetermined criteria. For example, a resource pool that has been disabled due to a failure condition may be determined to be operating normally after the failure condition has been resolved. Normal operation of the resource pool may be based on a comparison of the predetermined criteria with corresponding operating metrics of the resource pool. After the disabled resource pool has been determined to be operational, the disabled resource pool may be reintegrated back into the cloud computing environment to resume assigned processing responsibilities.

In another exemplary embodiment, information that corresponds to at least one from among the resource pools, the operating metrics, the latency metrics, the thresholds, and the remediation actions may be aggregated for documentation. A graphical representation of the aggregated information may also be generated. The graphical representation may correspond to a dashboard that includes the aggregated information. The graphical representation may be displayed for a user via a graphical user interface. Consistent with present disclosures, the graphical user interface may enable customized displays of the aggregated information based on input received from the user. For example, the user may interact with elements in the graphical representation to select and filter the aggregated information for a specific resource pool.

In another exemplary embodiment, an email alert may be generated. The email alert may include information that relates to the latency metrics, the thresholds, the resource pools, and the remediation actions. The email alert may be generated in advance of a failure for notification of an anticipated failure condition. The email alert may also be generated after completion of a remediation action for notification of a detected failure and the automated actions taken to resolve the failure condition. A responsible user such as, for example, a support team may be identified for the email alert based on the affected resource pool. The responsible user may be associated with the affected resource pool. Then, the email alert may be transmitted to the identified responsible user.

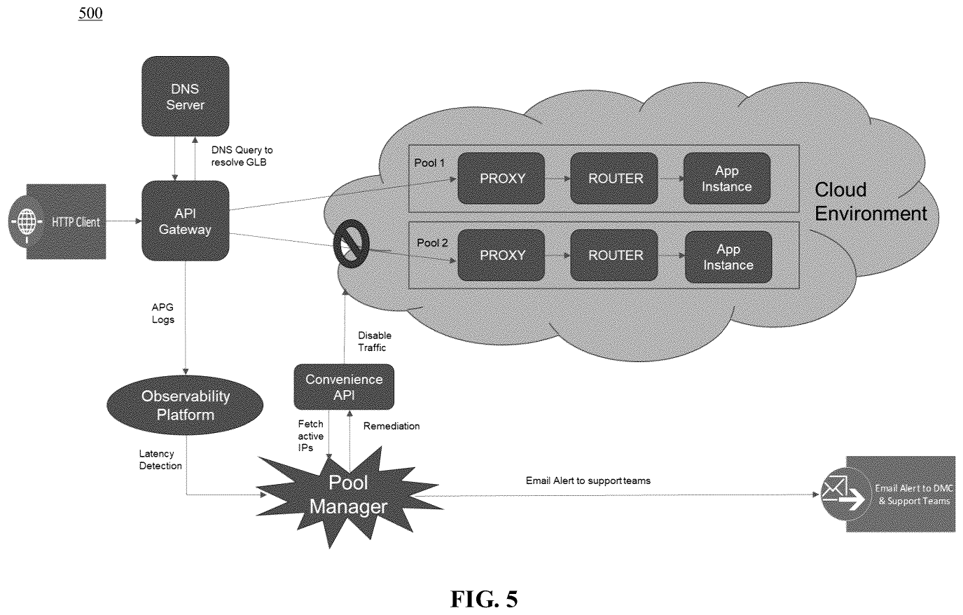

FIG. 5 is an architecture diagram 500 of an exemplary process for implementing a method for providing end-to-end monitoring outside an application boundary to facilitate automated resource pool management in a cloud computing environment. In FIG. 5, latency may be detected for applications at a layer outside the application boundary to enable identification of platform issues with network appliances. Additionally, convenience APIs may be called to disable network traffic from an impacted resource pool to resolve latency related failure conditions.

As illustrated in FIG. 5, a HTTP client may connect with a plurality of resource pools in a cloud computing environment via an API gateway. The API gateway may generate domain name system (DNS) queries and communicate with a DNS server to resolve routing issues. A resource pool manager may utilize an observability platform such as, for example, a SPLUNK platform to facilitate latency detection. The observability platform may aggregate operation logs from the API gateway to identify latency metrics.

The resource pool manager may also fetch active internet protocol (IP) address from a convenience API to identify active and inactive resource pools in the cloud environment. Consistent with present disclosures when a failure condition is detected, the resource pool manager may identify remediation actions and provide instructions to the convenience API. The convenience API may disable network traffic to the affected resource pool and remove it from the mix. The resource pool manager may also generate an email alert that includes information relating to the detected latency and the remediation action. The email alert may be transmitted to responsible support teams.

Accordingly, with this technology, an optimized process for providing end-to-end monitoring outside an application boundary to facilitate automated resource pool management in a cloud computing environment is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing end-to-end monitoring to facilitate automated resource pool management in a cloud computing environment, the method being implemented by at least one processor, the method comprising:
aggregating, by the at least one processor in real-time from an application programming interface gateway, a plurality of operating metrics for at least one resource pool;
parsing, by the at least one processor, the aggregated plurality of operating metrics to discover at least one latency metric for each of the at least one resource pool;
identifying, by the at least one processor, at least one threshold for each of the at least one resource pool, the at least one threshold corresponding to the at least one latency metric;
comparing, by the at least one processor, the at least one latency metric for each of the at least one resource pool with the corresponding at least one threshold;
automatically determining, by the at least one processor, at least one remediation action based on a result of the comparing; and
automatically initiating, by the at least one processor in real-time, the at least one remediation action.

2. The method of claim 1, further comprising:
generating, by the at least one processor, at least one email alert, the at least one email alert including information that relates to the at least one latency metric, the at least one threshold, the at least one resource pool, and the at least one remediation action;
identifying, by the at least one processor, at least one responsible user based on the at least one resource pool; and
transmitting, by the at least one processor, the at least one email alert to the at least one responsible user.

3. The method of claim 1, wherein the at least one latency metric corresponds to a communication time delay in a network flow of the at least one resource pool, the at least one resource pool relating to an application instance in the cloud computing environment.

4. The method of claim 1, wherein identifying the at least one threshold for each of the at least one resource pool further comprises:
aggregating, by the at least one processor, historical data for each of the at least one resource pool, the historical data including persisted information that relates to the plurality of operating metrics;
identifying, by the at least one processor using at least one model, at least one failure pattern based on the aggregated historical data;
determining, by the at least one processor, the at least one threshold based on the at least one failure pattern; and
associating, by the at least one processor, the determined at least one threshold with the corresponding at least one resource pool,
wherein the at least one model includes at least one from among a machine learning model, a mathematical model, a process model, and a data model.

5. The method of claim 1, wherein comparing the at least one latency metric with the corresponding at least one threshold further comprises:
determining, by the at least one processor for each of the at least one resource pool, a failure condition based on the at least one latency metric and the corresponding at least one threshold; and
determining, by the at least one processor, a failure level for the failure condition, the failure level corresponding to a criticality of the failure condition according to a predetermined guideline.

6. The method of claim 5, wherein automatically determining the at least one remediation action further comprises:
determining, by the at least one processor using at least one model, the at least one remediation action based on the failure condition and the corresponding failure level, the at least one remediation action including at least one from among an alerting action and a corrective action;
identifying, by the at least one processor using the plurality of operating metrics, an amount of the at least one resource pool that satisfies a predetermined operating requirement, the predetermined operating requirement relating to a minimum operating capacity of the cloud computing environment; and
validating, by the at least one processor, the at least one remediation action based on the identified amount,
wherein the alerting action corresponds to an automated notification of a potential failure as determined by the at least one model; and
wherein the corrective action corresponds to an automated disabling of network traffic to the at least one resource pool.

7. The method of claim 1, wherein automatically initiating the at least one remediation action further comprises:
generating, by the at least one processor, at least one request with instructions that correspond to the at least one remediation action;
transmitting, by the at least one processor, the at least one request to a network application programming interface that manages data flow for the at least one resource pool; and
confirming, by the at least one processor, that the at least one remediation action is completed based on a response from the network application programming interface.

8. The method of claim 1, further comprising:
monitoring, by the at least one processor, the at least one resource pool by using the plurality of operating metrics;
determining, by the at least one processor, that at least one disabled resource pool is operational according to predetermined criteria; and
reintegrating, by the at least one processor, the at least one disabled resource pool back into the cloud computing environment.

9. The method of claim 1, further comprising:
aggregating, by the at least one processor, information that corresponds to at least one from among the at least one resource pool, the plurality of operating metrics, the at least one latency metric, the at least one threshold, and the at least one remediation action;
generating, by the at least one processor, at least one graphical representation of the aggregated information, the at least one graphical representation corresponding to a dashboard that includes the aggregated information; and
displaying, by the at least one processor via a graphical user interface, the at least one graphical representation.

10. A computing device configured to implement an execution of a method for providing end-to-end monitoring to facilitate automated resource pool management in a cloud computing environment, the computing device comprising:
a processor;
a memory; and
a communication interface coupled to each of the processor and the memory, wherein the processor is configured to:
aggregate, in real-time from an application programming interface gateway, a plurality of operating metrics for at least one resource pool;
parse the aggregated plurality of operating metrics to discover at least one latency metric for each of the at least one resource pool;
identify at least one threshold for each of the at least one resource pool, the at least one threshold corresponding to the at least one latency metric;
compare the at least one latency metric for each of the at least one resource pool with the corresponding at least one threshold;
automatically determine at least one remediation action based on a result of the comparing; and
automatically initiate, in real-time, the at least one remediation action.

11. The computing device of claim 10, wherein the processor is further configured to:
generate at least one email alert, the at least one email alert including information that relates to the at least one latency metric, the at least one threshold, the at least one resource pool, and the at least one remediation action;
identify at least one responsible user based on the at least one resource pool; and
transmit the at least one email alert to the at least one responsible user.

12. The computing device of claim 10, wherein the at least one latency metric corresponds to a communication time delay in a network flow of the at least one resource pool, the at least one resource pool relating to an application instance in the cloud computing environment.

13. The computing device of claim 10, wherein, to identify the at least one threshold for each of the at least one resource pool, the processor is further configured to:
aggregate historical data for each of the at least one resource pool, the historical data including persisted information that relates to the plurality of operating metrics;
identify, by using at least one model, at least one failure pattern based on the aggregated historical data;
determine the at least one threshold based on the at least one failure pattern; and
associate the determined at least one threshold with the corresponding at least one resource pool,
wherein the at least one model includes at least one from among a machine learning model, a mathematical model, a process model, and a data model.

14. The computing device of claim 10, wherein, to compare the at least one latency metric with the corresponding at least one threshold, the processor is further configured to:
determine, for each of the at least one resource pool, a failure condition based on the at least one latency metric and the corresponding at least one threshold; and
determine a failure level for the failure condition, the failure level corresponding to a criticality of the failure condition according to a predetermined guideline.

15. The computing device of claim 14, wherein, to automatically determine the at least one remediation action, the processor is further configured to:
determine, by using at least one model, the at least one remediation action based on the failure condition and the corresponding failure level, the at least one remediation action including at least one from among an alerting action and a corrective action;
identify, by using the plurality of operating metrics, an amount of the at least one resource pool that satisfies a predetermined operating requirement, the predetermined operating requirement relating to a minimum operating capacity of the cloud computing environment; and
validate the at least one remediation action based on the identified amount,
wherein the alerting action corresponds to an automated notification of a potential failure as determined by the at least one model; and
wherein the corrective action corresponds to an automated disabling of network traffic to the at least one resource pool.

16. The computing device of claim 10, wherein, to automatically initiate the at least one remediation action, the processor is further configured to:
generate at least one request with instructions that correspond to the at least one remediation action;
transmit the at least one request to a network application programming interface that manages data flow for the at least one resource pool; and
confirm that the at least one remediation action is completed based on a response from the network application programming interface.

17. The computing device of claim 10, wherein the processor is further configured to:
monitor the at least one resource pool by using the plurality of operating metrics;
determine that at least one disabled resource pool is operational according to predetermined criteria; and
reintegrate the at least one disabled resource pool back into the cloud computing environment.

18. The computing device of claim 10, wherein the processor is further configured to:
aggregate information that corresponds to at least one from among the at least one resource pool, the plurality of operating metrics, the at least one latency metric, the at least one threshold, and the at least one remediation action;
generate at least one graphical representation of the aggregated information, the at least one graphical representation corresponding to a dashboard that includes the aggregated information; and
display, via a graphical user interface, the at least one graphical representation.

19. A non-transitory computer readable storage medium storing instructions for providing end-to-end monitoring to facilitate automated resource pool management in a cloud computing environment, the storage medium comprising executable code which, when executed by a processor, causes the processor to:
aggregate, in real-time from an application programming interface gateway, a plurality of operating metrics for at least one resource pool;
parse the aggregated plurality of operating metrics to discover at least one latency metric for each of the at least one resource pool;
identify at least one threshold for each of the at least one resource pool, the at least one threshold corresponding to the at least one latency metric;
compare the at least one latency metric for each of the at least one resource pool with the corresponding at least one threshold;
automatically determine at least one remediation action based on a result of the comparing; and
automatically initiate, in real-time, the at least one remediation action.

20. The storage medium of claim 19, wherein the at least one latency metric corresponds to a communication time delay in a network flow of the at least one resource pool, the at least one resource pool relating to an application instance in the cloud computing environment.
